(19) United States
(12) Patent Application Publication
(10) Pub. No.: US 2025/0158876 A1
(43) Pub. Date: May 15, 2025

(54) SYSTEMS AND METHODS TO CONTROL MODBUS REDUNDANCY

(71) Applicant: Schlumberger Technology Corporation, Sugar Land, TX (US)

(72) Inventor: Limin Chen, Katy, TX (US)

(21) Appl. No.: 18/945,817

(22) Filed: Nov. 13, 2024

Related U.S. Application Data
(60) Provisional application No. 63/598,985, filed on Nov. 15, 2023.

(51) Int. Cl. H04L 41/0668; H04L 12/40; H04L 43/0817

(52) U.S. Cl. CPC H04L 41/0668; H04L 12/40032; H04L 43/0817; H04L 2012/40221; H04L 2012/40228; H04L 2012/4026

(57) ABSTRACT

A system includes a programmable logic controller (PLC); a primary master device; a standby master device; and a plurality of slave devices, wherein the primary master device is configured to communicate with each of the plurality of slave devices, and wherein the PLC is configured to determine that the primary master device is in a failure state, and in response, the PLC is configured to switch from the primary master device to the standby master device such that the standby master device is configured to communicate with each of the plurality of slave devices.

### CROSS-REFERENCE TO RELATED APPLICATION

This application claims benefit to U.S. Provisional Patent Application No. 63/598,985, filed Nov. 15, 2023.

### BACKGROUND

Programmable logic controllers (PLCs) have been widely used in automation control systems due to their programming capability, reliability, and flexibility in a variety of different applications. The PLC can communicate with a plurality of devices using different industrial standard protocols. For example, Modbus is a data exchange protocol utilized in traditional and modern automation control systems connecting industrial electronics devices. In automation control systems that implement a Modbus communication protocol, there is a need for a configuration that reduces redundance traffic in the network and improves data acquisition speed without compromising the reliability and availability of traditional configurations.

### SUMMARY

A system according to one or more embodiments of the present disclosure includes a programmable logic controller (PLC); a primary master device; a standby master device; and a plurality of salve devices. According to one or more embodiments of the present disclosure, the primary master device is configured to communicate with each of the plurality of slave device, and the PLC is configured to determine that the primary master device is in a failure state, and in response, the PLC is configured to switch from the primary master device to the standby master device such that the standby master device is configured to communicate with each of the plurality of slave devices.

A system according to one or more embodiments of the present disclosure includes a programmable logic controller (PLC); a first communication module; a first interface module connected to the first communication module; a second communication module; and a second interface module connected to the second communication module. According to one or more embodiments of the present disclosure the first and second communication modules are connected to the PLC through the first and second interface modules and through an industrial network.

According to one or more embodiments of the present disclosure, a system for controlling equipment at a wellsite includes a programmable logic controller (PLC); a first communication module including a primary master device; a first interface module directly connected to the first communication module; a second communication module including a standby master device; a second interface module directly connected to the second communication module, wherein the first and second communication modules are connected to the PLC through the first and second interface modules and trough an industrial network; and a plurality of slave devices, wherein the primary master device of the first communication module is configured to communicate with each of the plurality of slave devices, and wherein the PLC is configured to determine that the primary master device of the first communication module is in a failure state, and in response, the PLC is configured to switch the primary master device of the first communication module to the standby master device of the second communication module such that the standby master device of the second communication module is configured to communicate with each of the plurality of slave devices.

According to one or more embodiments of the present disclosure, a method to facilitate communication in a network including a primary master device; a first interface module connected to the primary master device; a standby master device; a second interface module connected to the standby master device; a plurality of slave devices; and a programmable logic controller (PLC), wherein the primary master device is configured to communicate with each slave device of the plurality of slave devices, the method including; monitoring a health status of the primary master device; monitoring a communication status between the primary master device and each slave device of the plurality of slave devices; detecting a failure state in at least one of: the primary master device; and the communication status between the primary master device and each slave device of the plurality of slave devices; and switching from the primary master device to the standby master device such that the standby master device communicates with each slave device of the plurality of slave devices.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 shows a conceptual, schematic view of a control system for a drilling rig, according to one or more embodiments of the present disclosure;

FIG. 2 shows a conceptual, schematic view of the control system shown in FIG. 1, according to one or more embodiments of the present disclosure;

FIG. 3 shows a schematic view of a wellsite, according to one or more embodiments of the present disclosure;

FIG. 4 shows an example of a Modbus RTU (Remote Terminal Unit) network implemented on a conventional system;

FIG. 5 shows a schematic view of a system that may be used at a wellsite, according to one or more embodiments of the present disclosure;

FIG. 6 shows a schematic view of the system shown in FIG. 5 in which a remote interface module and/or a point-to-point communication module has failed, according to one or more embodiments of the present disclosure;

FIG. 7 shows a schematic view of the system shown in FIG. 5 in which a point-to-point communication module has lost communication to a Modbus network, according to one or more embodiments of the present disclosure; and

FIG. 8 shows a schematic view of the system shown in FIG. 5 in which a point-to-point communication module has lost power, according to one or more embodiments of the present disclosure.

### DETAILED DESCRIPTION

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

In the specification and appended claims, the terms “connect,” “connection,” “connected,” “in connection with,” and “connecting,” are used to mean “in direct connection with,” or “in connection with via one or more elements.” The terms “couple,” “coupled,” “coupled with,” “coupled together,” and “coupling” are used to mean “directly coupled together,” or “coupled together via one or more elements.” The term “set” is used to mean setting “one element” or “more than one element.” As used herein, the terms “up” and “down,” “upper” and “lower,” “upwardly” and “downwardly,” “upstream” and “downstream,” “uphole” and “downhole,” “above” and “below,” “top” and “bottom,” and other like terms indicating relative positions above or below a given point or element are used in this description to more clearly describe some embodiments of the disclosure. Commonly, these terms relate to a reference point at the surface from which drilling operations are initiated as being the top point and the total depth being the lowest point, wherein the well (e.g., wellbore, borehole) is vertical, horizontal, or slanted relative to the surface.

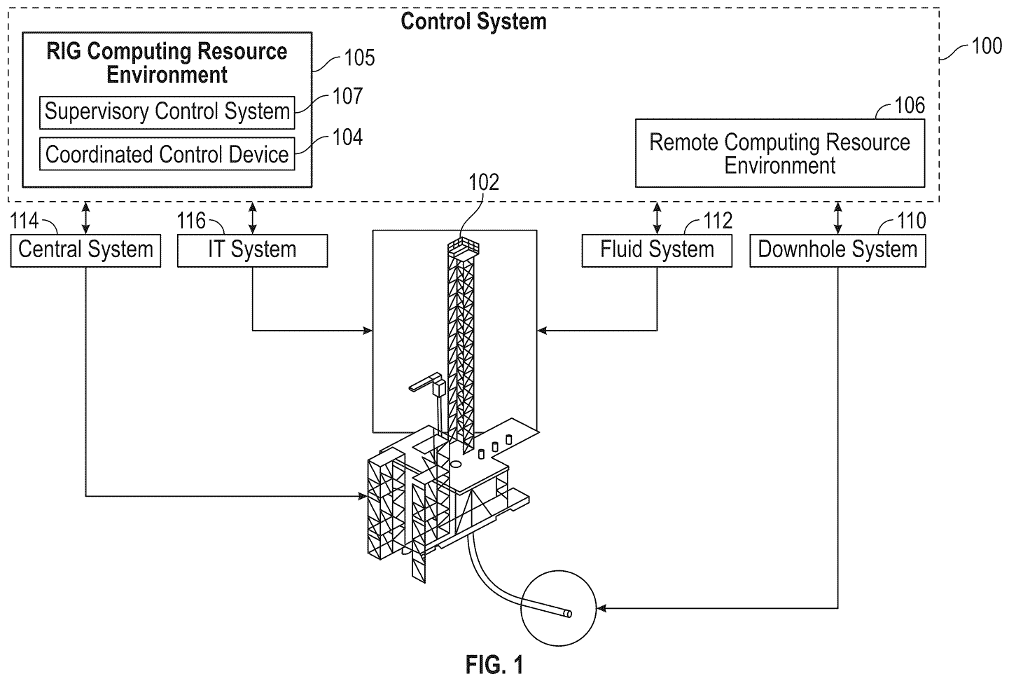

FIG. 1 shows a conceptual, schematic view of a control system 100 for a drilling rig 102, according to one or more embodiments of the present disclosure. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

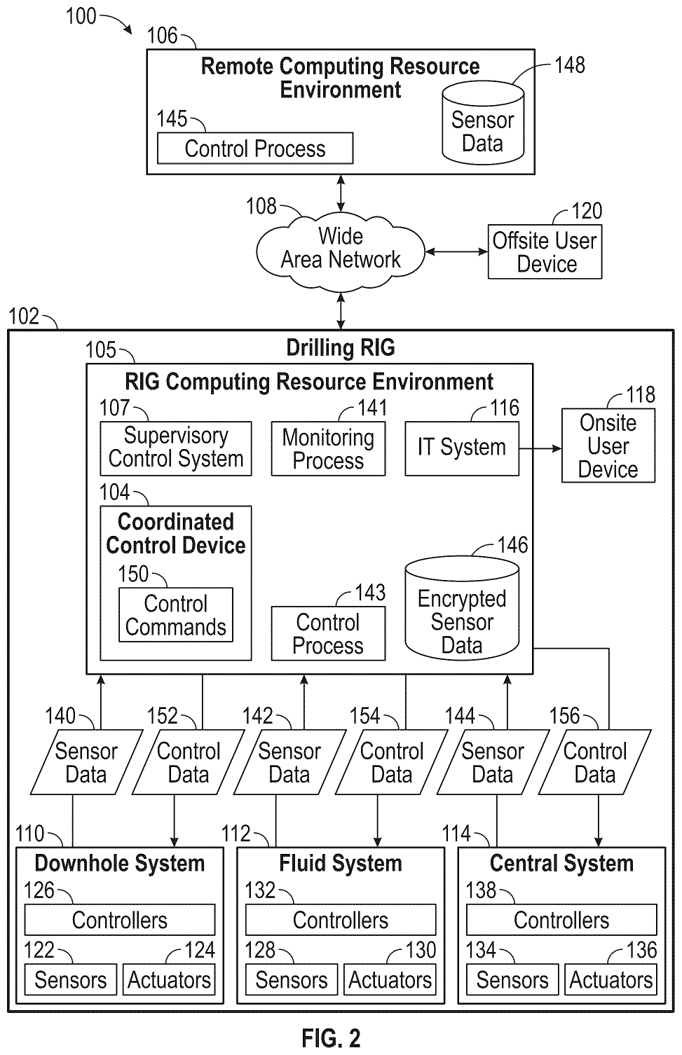

FIG. 2 shows a conceptual, schematic view of the control system 100 shown in FIG. 1, according to one or more embodiments of the present disclosure. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g., tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration.

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

### Modbus Redundancy in a PLC-Based Control System

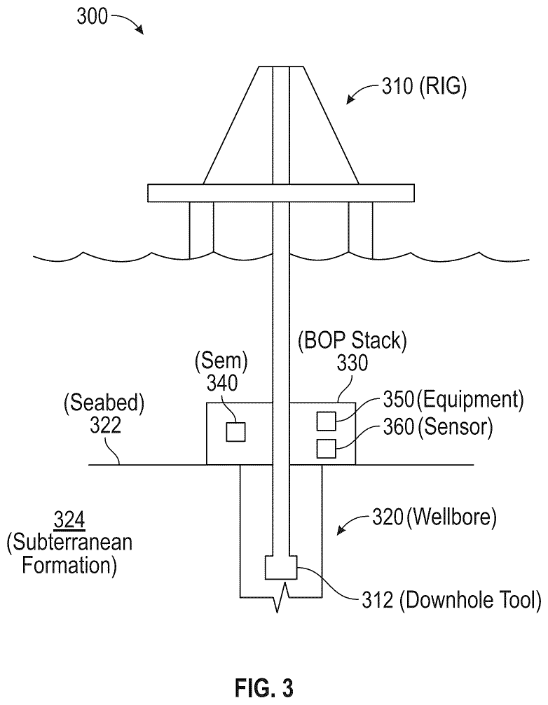

FIG. 3 shows a schematic view of a wellsite 300, according to an embodiment. The wellsite 300 may be on land or subsea. The wellsite 300 may include a drilling rig 310 positioned over a wellbore 320. As shown, the drilling rig 310 may control a downhole tool 312 that drills the wellbore 320 through a seabed 322 and down into a subterranean formation 324 therebelow.

The wellsite 300 may also include a blowout preventer (BOP) stack 330 positioned above or at least partially within the wellbore 320. The BOP stack 330 may provide pressure control for the wellbore 320.

The wellsite 300 may also include a subsea electronic module (SEM) 340. The SEM 340 may be connected to the BOP stack 330. The SEM 340 may communicate with one or more programmable logic controllers (e.g., described below). For example, the SEM 340 may transmit a status (e.g., position or state) of equipment (e.g., a subsea valve) to a surface PLC. In another example, the SEM 340 may receive instructions (e.g., a valve command) to actuate the equipment.

The wellsite 300 may also include equipment 350. The equipment 350 may be connected to and/or positioned on/within the drilling rig 310, the wellbore 320, the BOP stack 330, the SEM 340, or a combination thereof. The equipment 350 may be or include an actuator configured to actuate between at least a first position or state and a second position or state. More particularly, the equipment 350 may be or include a switch or a valve (e.g., a solenoid valve) in/on the BOP stack 330. In another embodiment, the equipment 350 may be or include a Modbus RTU network-compatible actuator such as a motor, a motor driver, a driver system, a Modbus RTU-based sensor, or a combination thereof.

The wellsite 300 may also include one or more sensors (one is shown: 360). The sensor 360 may be connected to and/or positioned at least partially on/within the wellbore 320, the BOP stack 330, the SEM 340, the equipment 350, or a combination thereof. The sensor 360 may be configured to sense (e.g., measure or monitor) one or more parameters in/of the wellbore 320, the BOP stack 330, the SEM 340, the equipment 350, or a combination thereof. The parameters may be or include temperature, pressure, trajectory, resistivity, porosity, sonic velocity, gamma ray, power (e.g., voltage and/or current), position/state (e.g., of the switch or valve), or a combination thereof.

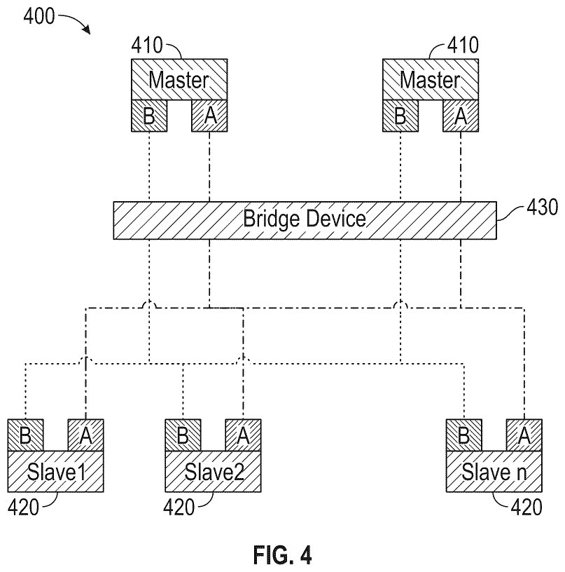

FIG. 4 shows an example of a Modbus RTU network implemented on a conventional system 400. Such a conventional system 400 typically includes a single master device that communicates with several slave devices. The communication is always initialized from the master device to either request data from one or more of the slave devices, or command one or more of the slave devices to start an action. Unfortunately, a conventional system 400 configured with only a single master device may experience a single point failure, which may compromise the reliability and availability of the network.

In a critical control system where redundance is required to ensure reliability and availability, multiple master devices 410 may be included in the system 400, as shown in the example provided in FIG. 4. In such case, the slave devices 420 may respond to the requests or commands of the master devices 410, one after another, which may contribute to a data collision issue. As shown in the conventional example shown in FIG. 4, a common solution is to include a bridge device 430 between the multiple master devices 410 and the slave devices 420 to handle the data collision issue. In such a network configuration with the bridge device 430, the master devices 410 usually communicate with the slave devices 420 individually and have their own data set.

In any case, when there is more than one master device 410 requesting data from a slave device 420 simultaneously with timing control, the system 400 will generate redundant data that consumes double (or more) of the available bandwidth on the network. This increased bandwidth consumption may create issues for limited bandwidth and high-speed communication network applications, such as in BOP data acquisition from subsea system. Furthermore, the conventional system 400, as previously described, may be unable to self-recover from a hardware failure even after the hardware issue is resolved.

In a multiple master device system according to one or more embodiments of the present disclosure, one of the master devices may be designated as the primary master device for actively processing the data, and the remaining master devices may be designated as standby master devices. According to this configuration, only one of the master devices (i.e., the primary master device) will be able to communicate with each of the slave devices. If the primary master device becomes unavailable due to a failure, for example, one of the standby master devices will then assume the role as the primary master device. The benefit of this configuration according to one or more embodiments of the present disclosure is a reduction in redundance traffic in the network and improved speed of data acquisition, while maintaining the same level of reliability and availability as the configuration of the conventional system 400, as previously described.

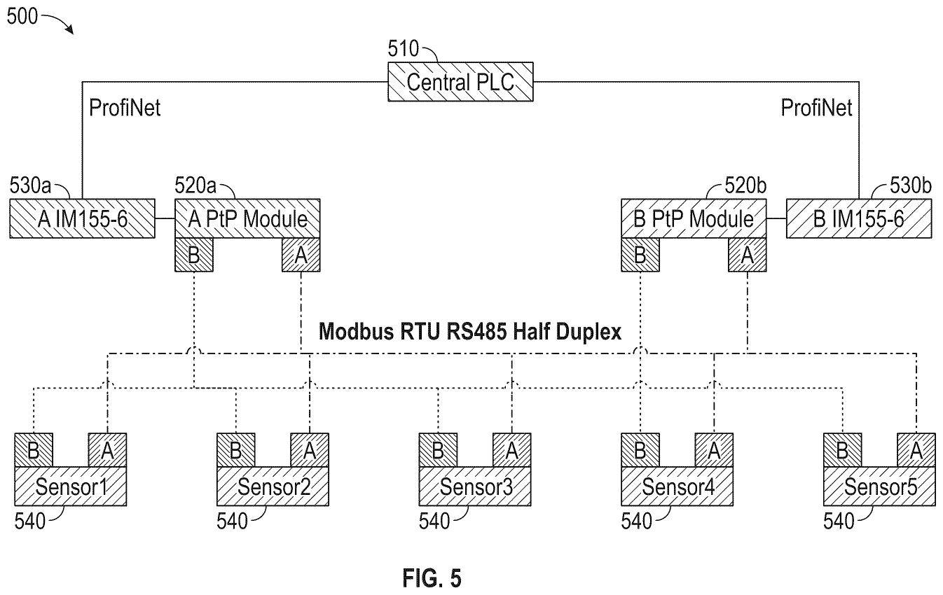

FIG. 5 shows a schematic view of a system 500 that may be used at the wellsite 300, according to one or more embodiments of the present disclosure. The system 500 may be or include a control system that is configured to control the drilling rig 310, the BOP stack 330, the SEM 340, the equipment 350, the sensor 360, or a combination thereof. The system 500 may implement a Modbus RTU communication protocol, according to one or more embodiments of the present disclosure. The Modbus RTU communication protocol runs on the RS232 or RS485 physical layer and data link layer.

The system 500 may include one or more programmable logic controllers (PLCs) 510. The PLC 510 may be located above the water (e.g., the sea). For example, the PLC 510 may be located on the drilling rig 310. Thus, the PLC 510 may be referred to as a surface PLC or a central PLC. The surface PLC 510 may be configured to receive input from a user and/or the sensor 360. For example, the input may be or include the one or more parameters. The surface PLC 510 may also be configured to transmit one or more (e.g., first) signals in response to the input.

The system 500 may include one or more point-to-point communication modules 520 connected to the surface PLC 510. According to one or more embodiments of the present disclosure, the one or more point-to-point communication modules 520 may be connected to the surface PLC 510 through an interface module 530. To facilitate this connection, the Modbus network may use a ProfiNet protocol, as shown in FIG. 5, for example. According to one or more embodiments of the present disclosure, the one or more point-to-point communication modules 520 may connected to the surface PLC 510 through ProfiNet as remote I/O devices. According to one or more embodiments of the present disclosure, the one or more point-to-point communication modules 520 are configured to be the Modbus master devices of the system 500, and as previously described, one of the point-to-point communication modules 520 may be designated as the primary master device 520a, and the remaining point-to-point communication module 520 may be designated as a standby master device 520b. As specifically shown in FIG. 5, for example, a first point-to-point communication module (or primary master device) 520a is connected to the surface PLC 510 through a first interface module 530a, and a second point-to-point communication module (or standby master device) 520b is connected to the surface PLC 510 through a second interface module 530b.

According to one or more embodiments of the present disclosure, the point-to-point communication modules 520 and the interface modules 530 may be located below the water. For example, the point-to-point communication modules 520 and the interface modules 530 may be connected to and/or located within the wellbore 320, the BOP stack 330, the SEM 340, the equipment 350, the sensor 360, or a combination thereof. Thus, the point-to-point communication modules 520 and the interface modules 530 may be referred to as subsea modules, and the subsea modules may be configured to connect to (e.g., communicate with) the surface PLC 510 (e.g., via a wire or wirelessly). The subsea modules 520, 530 may also be configured to connect to (e.g., communicate with) one another. According to one or more embodiments of the present disclosure, the subsea module 520 may not be directly connected to (e.g., able to communicate directly with) the surface PLC 510; rather, the communication between the surface PLC 510 and the subsea module 520 may instead go through the subsea module 530.

The system 500 shown in FIG. 5 is in a startup configuration. According to one or more embodiments of the present disclosure, at system 500 startup, the first point-to-point communication module 520a is in an active mode, and the second point-to-point communication module 520b is in a standby mode. According to one or more embodiments of the present disclosure, the first and second point-to-point communication modules 520a, 520b are not both in the active mode simultaneously. According to one or more embodiments of the present disclosure, the surface PLC 510 detects the status of the first point-to-point communication module 520a and the second point-to-point communication module 520b at startup. At system 500 startup, if both the first point-to-point communication module 520a and the second point-to-point communication module 520b are healthy, then the first point-to-point communication module 520a is active. However, if the first point-to-point communication module 520a is down at system 500 startup, then the second point-to-point communication module 520b will be active if healthy.

The system 500 may also include a plurality of slave devices 540. According to one or more embodiments of the present disclosure, the primary master device 520a is configured to communicate with each of the plurality of slave devices 540. For example, the primary master device 520a is configured to request data from at least one of the plurality of slave devices 540, and/or the primary master device 520a is configured to command the at least one of the plurality of slave devices 540 to initiate an action. The surface PLC 510 according to one or more embodiments of the present disclosure monitors the status of the primary master device 520a and the communication status between the primary master device 520a and the plurality of slave devices 540. If, and only if, the primary master device 520 experiences a failure, the surface PLC 510 is configured to switch from the primary master device 520a to the standby master device 520b such that the standby master device 520b is configured to communicate with each of the plurality of slave devices 540. In this way, the standby master device 520b can seamlessly take over communication with the plurality of slave devices 540 and any related activity in a timely manner and without or very minimal impact on the operation of the system 500 if a failure happens. That is, after the switch, the standby master device 520b is configured to request data from at least one of the plurality of slave devices 540, and/or the standby master device 520b is configured to command the at least one of the plurality of slave devices 540 to initiate an action.

According to one or more embodiments of the present disclosure, the surface PLC 510 provides fail-over logic during runtime to facilitate the seamless switch from the primary master device 520a to the standby master device 520b if the primary master device 520a enters a failure state. During the runtime, a user of the system 500 has the flexibility to control communication of the primary master device 520a or the standby master device 520b, as the case may be, with each of the plurality of slave devices 540, according to one or more embodiments of the present disclosure.

As further shown in FIG. 5, each of the first point-to-point communication module 520a and the second point-to-point communication module 520b includes an A side and a B side, for example. As also shown in FIG. 5, the plurality of slave devices 540 includes a plurality of sensors, each sensor of the plurality of sensors including an A side and a B side. According to one or more embodiments of the present disclosure, the A side of each sensor of the plurality of sensors is connected to the corresponding A sides of the first point-to-point communication module 520a and the second point-to-point communication module 520b via an A set of signal wires, and the B side of each sensor of the plurality of sensors is connected to the corresponding B sides of the first point-to-point communication module 520a and the second point-to-point communication module 520b via a B set of signal wires.

As previously mentioned, the surface PLC 510 of the system 500 may be located on a drilling rig 310 positioned above a subsea wellbore 320. According to one or more embodiments of the present disclosure, the first and second point-to-point communication modules 520a, 520b and the first and second interface modules 530a, 530b may be located in the SEM 340, which is attached to the BOP stack 330 that is at least partially above the subsea wellbore 320. In some embodiments of the present disclosure, the surface PLC 510 is configured to receive one or more parameters that are measured by a sensor 360 and to transmit a first signal to the one or more of the first and second point-to-point communication modules 520a, 520b and the first and second interface modules 530a, 530b in response to the one or more parameters. One or more of the first and second point-to-point communication modules 520a, 520b and the first and second interface modules 530a, 530b are configured to transmit a second signal to an industrial network, such as the Modbus network as previously described, in response to the first signal. According to one or more embodiments of the present disclosure, the Modbus network may be distributed across the BOP stack 330, the SEM 340, the equipment 350, or a combination thereof. According to one or more embodiments of the present disclosure, the plurality of slave devices 540, which may include a plurality of sensors, is connected to the SEM 340, the BOP stack 330, the equipment 350, or a combination thereof. As such, the plurality of slave devices 540 communicate within the Modbus network, according to one or more embodiments of the present disclosure.

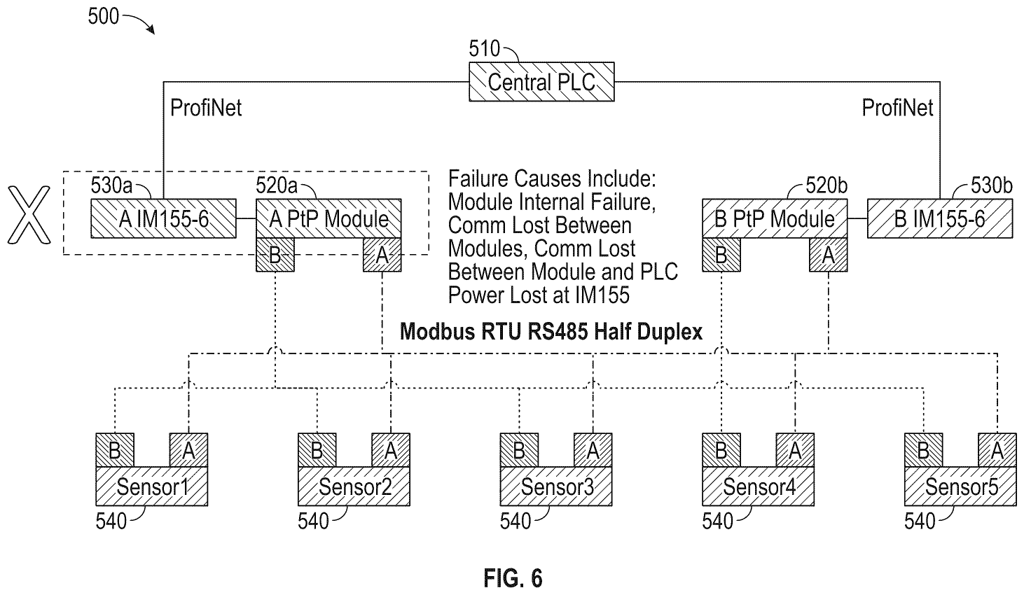

FIG. 6 shows a schematic view of the system 500 shown in FIG. 5 in which a remote interface module and/or a point-to-point communication module has failed, according to one or more embodiments of the present disclosure. During operation, if the first interface module 530a and/or the first point-to-point communication module 520a fails, and the second interface module 530b and the second point-to-point communication module 520b is healthy, then the surface PLC 510 is configured to switch communication from the first point-to-point communication module 520a to the second point-to-point communication module 520b. Similarly, during operation, if the second interface module 530b and/or the second point-to-point communication module 520b fails, and the first interface module 530a and the first point-to-point communication module 520a is healthy, then the surface PLC 510 is configured to switch communication from the second point-to-point communication module 520b to the first point-to-point communication module 520a. According to one or more embodiments of the present disclosure, failure events of this type may include a module internal failure, communication lost between modules, communication lost between a module and the surface PLC 510, or power lost at the interface module. According to one or more embodiments of the present disclosure, module status detection is called when a failure event happens in the hardware interrupt OB (origination function block). According to one or more embodiments of the present disclosure, the switching time from a failed module to a healthy module may take less than about one second.

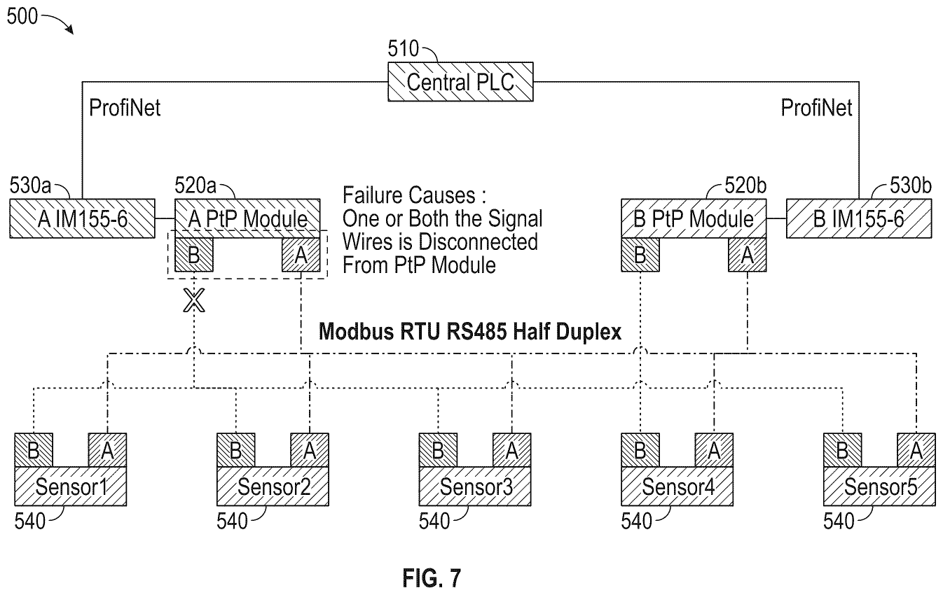

FIG. 7 shows a schematic view of the system 500 shown in FIG. 5 in which a point-to-point communication module has lost communication to the Modbus network, according to one or more embodiments of the present disclosure. During operation, if the first point-to-point communication module 520a is disconnected from the Modbus network via one or both of the signal wires, and the second point-to-point communication module 520b is healthy, then the surface PLC 510 is configured to switch communication from the first point-to-point communication module 520a to the second point-to-point communication module 520b. Similarly, during operation, if the second point-to-point communication module 520b is disconnected from the Modbus network via one or both of the signal wires, and the first point-to-point communication module 520a is healthy, then the surface PLC 510 is configured to switch communication from the second point-to-point communication module 520b to the first point-to-point communication module 520a. According to one or more embodiments of the present disclosure, this status is being monitored by each Modbus command call if and only if all commands showing error will be considered wire disconnected at the point-to-point communication module 520a, 520b. According to one or more embodiments of the present disclosure, the switching time after this type of failure event may take about five seconds.

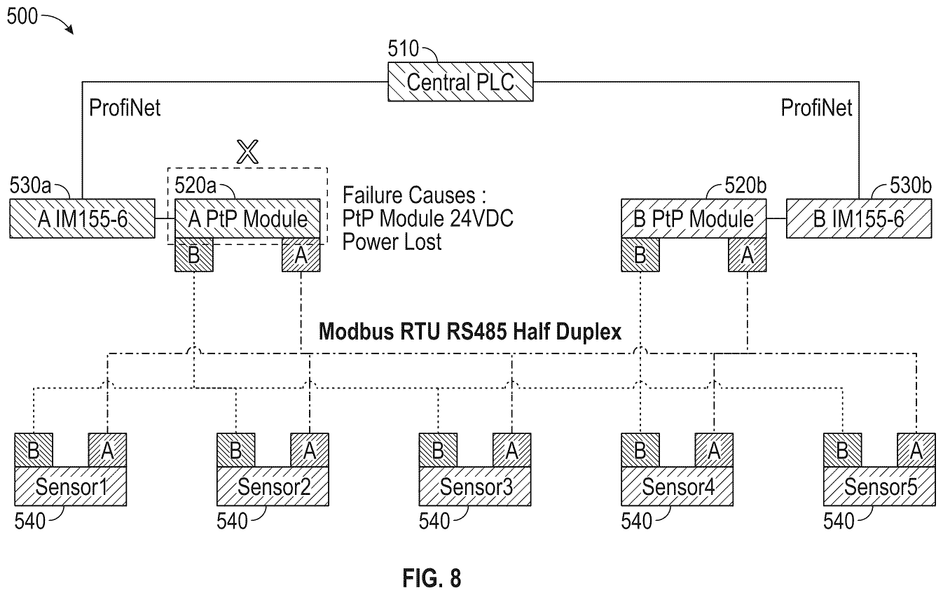

FIG. 8 shows a schematic view of the system 500 shown in FIG. 5 in which a point-to-point communication module has lost power, according to one or more embodiments of the present disclosure. During operation, if the first point-to-point communication module 520a loses power, and the second point-to-point communication module 520b is healthy, then the surface PLC 510 is configured to switch communication from the first point-to-point communication module 520a to the second point-to-point communication module 520b. Similarly, during operation, if the second point-to-point communication module 520b loses power, and the first point-to-point communication module 520a is healthy, then the surface PLC 510 is configured to switch communication from the second point-to-point communication module 520b to the first point-to-point communication module 520a. According to one or more embodiments of the present disclosure, this status is being monitored by each Modbus command call if and only if all commands showing error will be considered wire disconnected at the point-to-point communication module 520a, 520b. According to one or more embodiments of the present disclosure, the switching time after this type of failure event may take about five seconds.

A system according to one or more embodiments of the present disclosure utilizes the Siemens module monitoring feature—the hardware interrupt OB and status tag in configuration settings—to detect the specific hardware (remote I/O IM and point-to-point communication module) failure.

A system according to one or more embodiments of the present disclosure uses the Modbus function feedback and internal logic calculation to define the device status for wire disconnection failure detection.

A system according to one or more embodiments of the present disclosure uses a lock/unlock function to control the communication between the Modbus master and slave for each communication channel in the runtime for master role switching.

A system according to one or more embodiments of the present disclosure uses an auto self-restart sequence to resume normal operation when the hardware issue is resolved.

In a system according to one or more embodiments of the present disclosure, Modbus master device switching is implemented to reduce bandwidth consumption and improve communication speed while maintaining the same level of the redundancy requirement for the critical control system.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system comprising:
a programmable logic controller (PLC);
a primary master device;
a standby master device; and
a plurality of slave devices,
wherein the primary master device is configured to communicate with each of the plurality of slave devices, and
wherein the PLC is configured to determine that the primary master device is in a failure state, and in response, the PLC is configured to switch from the primary master device to the standby master device such that the standby master device is configured to communicate with each of the plurality of slave devices.

2. The system of claim 1, wherein the primary master device is configured to request data from at least one of the plurality of slave devices; or command the at least one of the plurality of slave devices to initiate an action.

3. The system of claim 1, wherein when the PLC determines that the primary master device is in a failure state, the standby master device is configured to request data from at least one of the plurality of slave devices; or command the at least one of the plurality of slave devices to initiate an action.

4. A system comprising:
a programmable logic controller (PLC);
a first communication module;
a first interface module connected to the first communication module;
a second communication module; and
a second interface module connected to the second communication module,
wherein the first and second communication modules are connected to the PLC through the first and second interface modules and through an industrial network.

5. The system of claim 4, wherein the industrial network uses a ProfiNet protocol.

6. The system of claim 4, wherein the first and second communication modules are connected to the PLC through the industrial network as remote I/O devices.

7. The system of claim 4, wherein the first communication module comprises a primary master device, and wherein the second communication module comprises a standby master device.

8. The system of claim 4, wherein, at system startup, the first communication module is in an active mode, and the second communication module is in a standby mode, and wherein the first and second communication modules are not both in the active mode simultaneously.

9. The system of claim 4,
wherein each of the first communication module and the second communication module comprises an A side and a B side;
wherein the system further comprises a plurality of sensors, each sensor of the plurality of sensors comprising an A side and a B side,
wherein the A side of each sensor of the plurality of sensors is connected to the corresponding A sides of the first communication module and the second communication module, and
wherein the B side of each sensor of the plurality of sensors is connected to the corresponding B sides of the first communication module and the second communication module.

10. The system of claim 9,
wherein the A side of each sensor of the plurality of sensors is connected to the corresponding A sides of the first communication module and the second communication module via an A set of signal wires, and
wherein the B side of each sensor of the plurality of sensors is connected to the corresponding B sides of the first communication module and the second communication module via a B set of signal wires.

11. The system of claim 10, wherein the first communication module is configured to communicate with each sensor of the plurality of sensors via one of:
the A side of the first communication module and the corresponding A side of the plurality of sensors; and
the B side of the first communication module and the corresponding B side of the plurality of sensors, and
wherein the PLC is configured to determine that the one of the A side and the B side of the first communication module is in a failure state, and in response, the PLC is configured to switch to the other of the A side and the B side of first communication module that is not in the failure state.

12. The system of claim 8,
wherein the system further comprises a plurality of slave devices,
wherein the primary master device of the first communication module is configured to communicate with each of the plurality of slave devices, and
wherein the PLC is configured to determine that the primary master device of the first communication module is in a failure state, and in response, the PLC is configured to switch the primary master device of the first communication module to the standby master device of the second communication module such that the standby master device of the second communication module is configured to communicate with each of the plurality of slave devices.

13. A system for controlling equipment at a wellsite, the system comprising:
a programmable logic controller (PLC);
a first communication module comprising a primary master device;
a first interface module directly connected to the first communication module;
a second communication module comprising a standby master device;
a second interface module directly connected to the second communication module, wherein the first and second communication modules are connected to the PLC through the first and second interface modules and through an industrial network; and
a plurality of slave devices,
wherein the primary master device of the first communication module is configured to communicate with each of the plurality of slave devices, and
wherein the PLC is configured to determine that the primary master device of the first communication module is in a failure state, and in response, the PLC is configured to switch the primary master device of the first communication module to the standby master device of the second communication module such that the standby master device of the second communication module is configured to communicate with each of the plurality of slave devices.

14. The system of claim 13, wherein the industrial network uses a ProfiNet protocol.

15. The system of claim 13,
wherein each of the first communication module and the second communication module comprises an A side and a B side;
wherein the plurality of slave devices comprises a plurality of sensors, each sensor of the plurality of sensors comprising an A side and a B side,
wherein the A side of each sensor of the plurality of sensors is connected to the corresponding A sides of the first communication module and the second communication module, and
wherein the B side of each sensor of the plurality of sensors is connected to the corresponding B sides of the first communication module and the second communication module.

16. The system of claim 15,
wherein the A side of each sensor of the plurality of sensors is connected to the corresponding A sides of the first communication module and the second communication module via an A set of signal wires, and
wherein the B side of each sensor of the plurality of sensors is connected to the corresponding B sides of the first communication module and the second communication module via a B set of signal wires.

17. The system of claim 13,
wherein the PLC is located at surface on a drilling rig positioned above a subsea wellbore, and
wherein the first communication module, the first interface module, the second communication module, and the second interface module are located in a subsea electronic module (SEM), which is attached to a blowout preventer (BOP) stack that is at least partially above the subsea wellbore, and
wherein the industrial network is distributed across the BOP stack.

18. The system of claim 17, wherein the plurality of slave devices is connected to the SEM, the BOP stack, the equipment, or a combination thereof.

19. The system of claim 18, wherein the plurality of slave devices comprises a plurality of sensors.

20. A method to facilitate communication in a network comprising: a primary master device; a first interface module connected to the primary master device; a standby master device; a second interface module connected to the standby master device; a plurality of slave devices; and a programmable logic controller (PLC), wherein the primary master device is configured to communicate with each slave device of the plurality of slave devices, the method comprising:
monitoring a health status of the primary master device;
monitoring a communication status between the primary master device and each slave device of the plurality of slave devices;
detecting a failure state in at least one of: the primary master device; and the communication status between the primary master device and each slave device of the plurality of slave devices; and
switching from the primary master device to the standby master device such that the standby master device communicates with each slave device of the plurality of slave devices.
